(19) United States
(12) Patent Application Publication
(10) Pub. No.: US 2025/0182717 A1
(43) Pub. Date: Jun. 5, 2025

(54) CONTROL METHOD, CONTROL APPARATUS, AND ELECTRONIC DEVICE

(71) Applicant: Lenovo (Beijing) Limited, Beijing (CN)

(72) Inventor: Longhui CHEN, Beijing (CN)

(21) Appl. No.: 18/965,264

(22) Filed: Dec. 2, 2024

(30) Foreign Application Priority Data
Nov. 30, 2023 (CN) 202311631457.8

(51) Int. Cl. G09G 5/02; G09G 5/36

(52) U.S. Cl. CPC G09G 5/02; G09G 5/36; G09G 2320/0666

(57) ABSTRACT

A control method includes obtaining a second parameter through a transmission channel, obtaining a first application, the first application belonging to a first device, rendering a display content of the first application in a running status based on the color mode represented by the second parameter, and sending the display content through the transmission channel to the second device, so that a visual effect of the display content on the second device is consistent with a visual effect of a display content of a second application displayed on the second device. The transmission channel is a channel established with a second device. The second parameter represents a color mode of the second device. The color mode at least indicates a foreground color and a background color of an application. The foreground color contrasts with the background color.

### CROSS REFERENCE TO RELATED APPLICATION

The present disclosure claims priority to Chinese Patent Application No. 202311631457.8, filed on Nov. 30, 2023, the entire content of which is incorporated herein by reference.

### TECHNICAL FIELD

The present disclosure is related to the data processing and computer vision field and, more particularly, to a control method, a control apparatus, and an electronic device.

### BACKGROUND

Color modes (such as dark mode and light mode, day mode and night mode) are able to be set on both mobile devices and display devices. The mobile devices are configured to cast screens to the display devices. When the color modes of the mobile devices and the display devices are different, screen switching of the display devices is abrupt, which affects the user viewing experience. Moreover, the user needs to manually change the color modes of the moving devices to update the display contents casted to the display devices.

### SUMMARY

An aspect of the present disclosure provides a control method. The method includes obtaining a second parameter through a transmission channel, obtaining a first application, the first application belonging to a first device, rendering a display content of the first application in a running status based on the color mode represented by the second parameter, and sending the display content through the transmission channel to the second device, so that a visual effect of the display content on the second device is consistent with a visual effect of a display content of a second application displayed on the second device. The transmission channel is a channel established with a second device. The second parameter represents a color mode of the second device. The color mode at least indicates a foreground color and a background color of an application. The foreground color contrasts with the background color. The display content of the first application is used to be displayed on the second device. The second application belongs to the second device.

An aspect of the present disclosure provides an electronic device including a communication assembly and one or more processors. The communication assembly is configured to establish a transmission channel with a second device. The one or more processors is configured to obtain a first application, the first application belonging to a first device, render a display content of the first application in a running status based on the color mode represented by the second parameter, and send the display content through the transmission channel to the second device, so that a visual effect of the display content on the second device is consistent with a visual effect of a display content of a second application displayed on the second device. The transmission channel is a channel established with a second device. The second parameter represents a color mode of the second device. The color mode at least indicates a foreground color and a background color of an application. The foreground color contrasts with the background color. The display content of the first application is used to be displayed on the second device. The second application belongs to the second device.

An aspect of the present disclosure provides a control apparatus including a communication module and one or more processors. The communication module is configured to establish a transmission channel with a second device. The one or more processors is configured to obtain a first application, the first application belonging to a first device, render a display content of the first application in a running status based on the color mode represented by the second parameter, and send the display content through the transmission channel to the second device so that a visual effect of the display content on the second device is consistent with a visual effect of a display content of a second application displayed on the second device. The transmission channel is a channel established with a second device. The second parameter represents a color mode of the second device. The color mode at least indicates a foreground color and a background color of an application. The foreground color contrasts with the background color. The display content of the first application is used to displayed on the second device. The second application belongs to the second device.

### BRIEF DESCRIPTION OF THE DRAWINGS

FIG. 1 illustrates a schematic flowchart of a control method according to some embodiments of the present disclosure.

FIG. 2 illustrates a schematic diagram showing a first device and a second device in a control method according to some embodiments of the present disclosure.

FIG. 3 illustrates a schematic diagram showing a first device and a second device in another control method according to some embodiments of the present disclosure.

FIG. 4 illustrates a schematic flowchart of another control method according to some embodiments of the present disclosure.

FIG. 5 illustrates a schematic flowchart of another control method according to some embodiments of the present disclosure.

FIG. 6 illustrates a schematic diagram showing a first device and a second device in another control method according to some embodiments of the present disclosure.

FIG. 7 illustrates a schematic diagram showing a first device and a second device in another control method according to some embodiments of the present disclosure.

FIG. 8 illustrates a schematic structural diagram of a control apparatus according to some embodiments of the present disclosure.

FIG. 9 illustrates a schematic structural diagram of an electronic device according to some embodiments of the present disclosure.

### DETAILED DESCRIPTION OF THE EMBODIMENTS

To make the objectives, features, and advantages of the present disclosure clear and easy to understand, the technical solutions of embodiments of the present disclosure are described in detail below in conjunction with the accompanying drawings of embodiments of the present disclosure. Obviously, the described embodiments are only some embodiments of the present disclosure and not all embodiments. Based on embodiments in the present disclosure, all other embodiments obtained by those skilled in the art without creative effort are within the scope of the present disclosure.

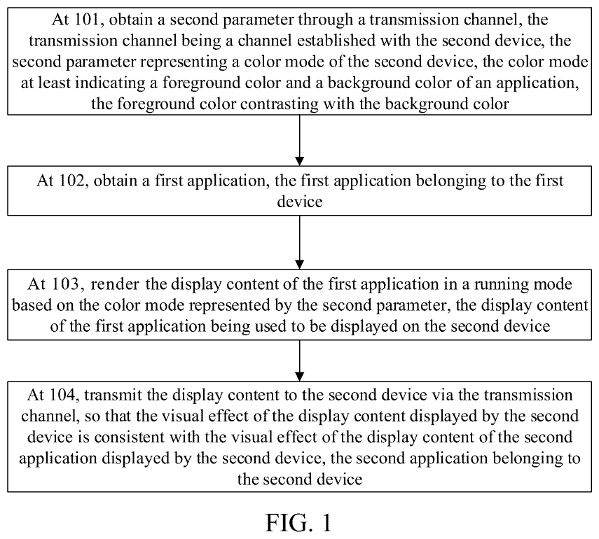

Embodiments of the present disclosure provide a control method to automatically modify a display mode of a display content to a display mode of the second device when a first device performs screen projection onto a second device. As shown in FIG. 1, the method includes the following processes.

At 101, a second parameter is obtained through a transmission channel. The transmission channel is a channel established with the second device. The second parameter represents a color mode of the second device. The color mode at least indicates a foreground color and a background color of an application. The foreground color contrasts with the background color.

In some embodiments, the transmission channel between the first device and the second device can be established in various methods.

In method 1, wireless screen projection is realized through a screen projection application (such as AirDroid, ApowerMirror, and Vysor). The transmission channel between the first device and the second device can be established through technologies, such as Miracast (a wireless display standard), Google Cast (a media transmission protocol), AirPlay (a media transmission protocol), Wireless Display (a wireless HD technology), or Wi-Fi Direct (a wireless connectivity technology).

In method 2, wired screen projection is realized via a connection cable. The transmission channel between the first device and the second device can be established via a connection cable, such as USB (Universal Serial Bus), and HDMI (High-Definition Multimedia Interface).

In method 3, wireless screen projection is realized through data transmission technology. The transmission channel between the first device and the second device can be established through WebSocket (a Web transmission technology) and WebRTC (a Web transmission technology).

The second parameter of the second device can be obtained through the transmission channel. The second parameter can represent the color mode of the second device. The color mode can include two modes. That is, the color mode can switch between the two modes. For example, the color mode can include a dark mode and a light mode. The user can switch between the dark mode and the light mode of the color mode to satisfy the requirements of the user to color change in the display content.

In some embodiments, the color mode can include a dark mode and a light mode, a daytime mode and a night mode, an eye-care mode and a normal mode, a high contrast mode and a normal mode, a translucent mode and an opaque mode, etc.

The color mode can at least indicate the foreground color and the background color of the application. The foreground color can contrast with the background color.

For example, in the eye-care mode, the background color of the application can be set to green to protect vision of the user, while the foreground color (including the font color of the application) can be set to a color that contrasts with green to allow the user to clearly view the content in the application.

The color mode can also indicate the contrast of the application (such as a high contrast mode, the readability of the content being enhanced by setting the high contrast), and the transparency (such as translucent mode, the application interface having a translucent appearance by setting the transparency), which can be selected and set according to the user needs.

At 102, the first application is obtained. The first application belongs to the first device.

The first application can be obtained and can be an application on the first device or the operating system of the first device.

At 103, the display content of the first application in a running mode can be rendered based on the color mode represented by the second parameter. The display content of the first application is used to be displayed on the second device.

Screen projection can include capturing the display content of the first device (i.e., the display content when the first application is in the running status), and then the display content can be mirrored and transmitted to the second device for display. Thus, when the color mode of the first device is not consistent with the color mode of the second device, the display content displayed originally by the second device based on the color mode of the second device can be suddenly projected and switched to the display content of another color mode (i.e., the color mode of the first device). Then, to not change the color mode of the display content of the second device before and after the screen projection, the display content of the first application in the running status may need to be rendered based on the color mode represented by the second parameter.

Rendering the display content of the first application in the running status based on the color mode represented by the second parameter can include at least one of the following methods.

In method 1, color space (e.g., an RGB (red, green, and blue original color channels) color mode) of the display content of the first application in the running status is converted.

In method 2, the contrast of the display content of the first application in the running status is adjusted.

In method 3, blue light filtering is performed on the display content of the first application in the running status by reducing value B in the RGB color mode.

In method 4, the transparency of the display content of the first application in the running status is adjusted.

At 104, the display content is transmitted to the second device via the transmission channel, so that the visual effect of the display content displayed by the second device is consistent with the visual effect of the display content of the second application displayed by the second device. The second application belongs to the second device.

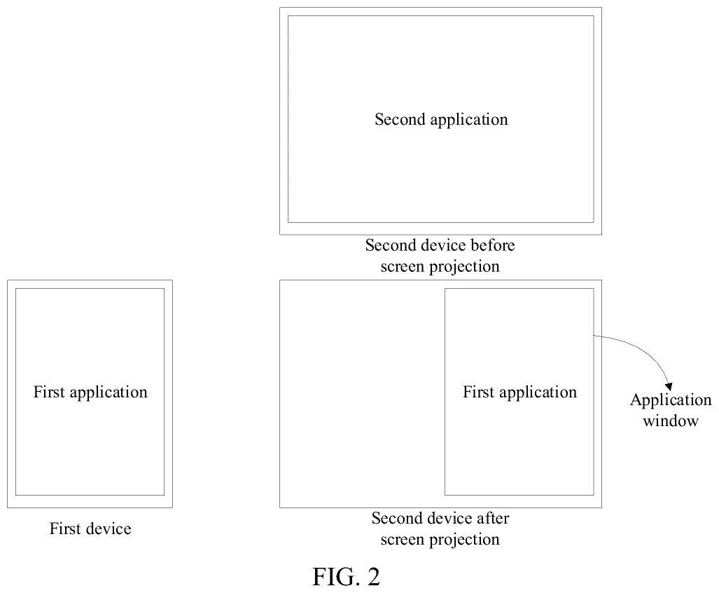

As shown in FIG. 2, based on color mode represented based on the second parameter, the first device renders the display content of the first application in the running status. The rendered display content can be transmitted to the second device in the form of a video stream through the transmission channel. The second device can receive the video stream, obtain the display content after performing the decoding on the video stream, establish an application window having the same dimension as the display content of the first application, and display the display content in the application window. The visual effect of the display content displayed by the second device can be consistent with the visual effect of the display content of the second application displayed by the second device (the application on the second device. That is, the color modes can be consistent, the switching of the projected pictures can be smooth and seamless.

In this embodiment, the second parameter of the second device can be obtained via the transmission channel. The display content of the first application in the running status can be rendered based on the color mode represented by the second parameter. The rendered display content can be then sent to the second device for display. Thus, during the screen projection, the visual effect of the display content projected onto the second device can be consistent with the visual effect of the display content of the second device before the screen projection. Thus, the projected pictures can be switched more smoothly, which can significantly improve the user experience of the user.

Embodiments of the present disclosure can further provide a control method. The method can further include configuring the second parameter based on the virtual screen. The virtual screen can be established based on the dimension and the target display area of the screen of the second device.

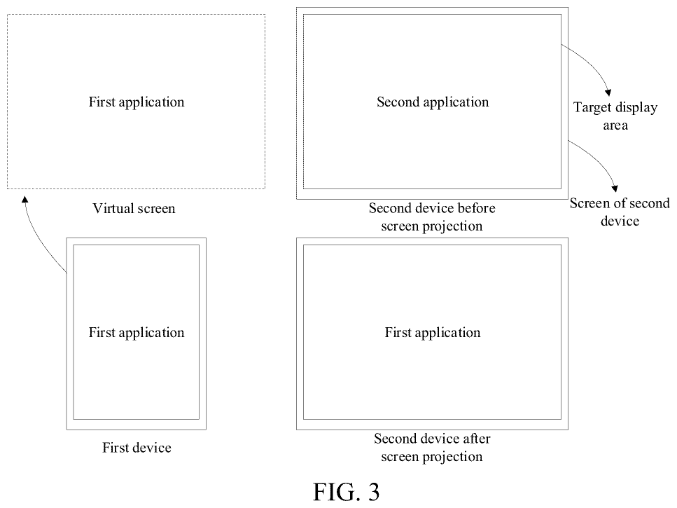

The target display area can be a display area in the second device configured to display the rendered display content sent by the first device. The display area can be an application window established in the second device or an area of the second device for displaying the content. As shown in FIG. 3, the dimension of the target display area of the second device is not equal to the dimension of the screen of the second device. When the target display area of the second device and the screen of the second device have different dimensions, the virtual screen can be established based on the target display area of the second device.

If the display content of the first application in the running status is only rendered based on the color mode represented by the second parameter, the dimension of the display content displayed on the second device after the screen projection can be set based on the dimension of the screen of the first device. Thus, if the dimension of the display content of the second device needs to be the same as the dimension of the screen or the target display area of the second device, as shown in FIG. 3, the virtual screen needs to be established in the first device based on the dimension of the screen and the target display area of the second device. The virtual screen can be a virtual display area, which is not displayed on the screen of the first device. During screen projection, the display content in the virtual screen can be captured by a projection application or a projection protocol. Then, the captured display content can be sent to the second device for display. The second device can receive the display content of the first application in the running status rendered by the first device and then display the display content of the first application in the running status in the target display area.

After establishing the virtual screen based on the dimension of the screen and the target display area of the second device, the second parameter may need to be configured based on the virtual screen. Thus, the color mode of the display content on the virtual screen can be the same as the color mode of the second device.

The user can also set the dimension of the virtual screen on the first device. If the first device detects a change in the dimension of the virtual screen, the changed dimension of the virtual screen can be sent to the second device. After receiving the changed dimension of the virtual screen, the dimension of the projected display content can be changed.

In this embodiment, by establishing the virtual screen on the first device based on the dimension of the screen of the second device and the target display area, the first device can configure the second parameter based on the virtual screen. The first device can render the display content of the first application in the running status based on the dimension of the screen of the second device and the target display area to further improve the effect of the screen projection and the user experience.

Embodiments of the present disclosure further provide a control method. Rendering the display content of the first application in the running status based on the second parameter can include rendering the display content of the first application in the running status based on the virtual screen.

The display content of the first application in the running status can be rendered based on the virtual screen. Precise adaptation can be performed according to the dimension of the virtual screen (i.e., the dimension of the screen of the second device and the target display area) to achieve the optimal visual effect. The rendering process is not simply scaling also can include fine adjustment to fonts, icons, and other interface elements to maintain the balance and readability of the display content.

In this embodiment, when the display content of the first application in the running status rendered based on the virtual screen is sent to the second device for display, no distortion may occur. The user can obtain the display content consistent with the picture ratio before the screen projection of the second device. When the user views the display content of the first device on the second device, the user may not need to worry about the problems of the image distortion or information being incomplete. The user can have enjoyable screen projection experience. Thus, the screen projection can become smarter, more flexible, and more user friendly.

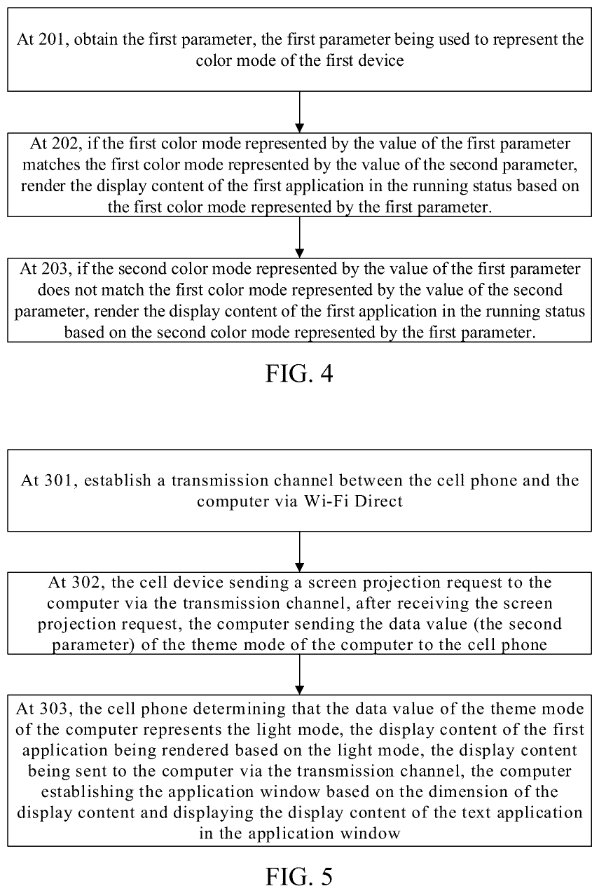

Embodiments of the present disclosure further provide a control method. As shown in FIG. 4, rendering the display content of the first application in the running status based on the color mode represented by the second parameter includes the following processes.

At 201, the first parameter is obtained. The first parameter is used to represent the color mode of the first device.

The first parameter is obtained. The first parameter can represent the color mode of the first device. The color mode can include a first color mode and a second color mode.

At 202, if the first color mode represented by the value of the first parameter matches the first color mode represented by the value of the second parameter, the display content of the first application in the running status is rendered based on the first color mode represented by the first parameter.

If the first color mode represented by the value of the first parameter matches the first color mode represented by the value of the second parameter, the display content of the first application in the running status can be directly rendered based on the first color mode represented by the first parameter.

For example, the color mode of the first device represented by the first parameter can include a dark mode and a light mode. The first color mode represented by the value of the first parameter can be the dark mode, and the first color mode represented by the value of the second parameter can also be the dark mode. Then, the display content of the first application in the running status may not need to be rendered based on the second parameter. The display content of the first application in the running status can be directly rendered based on the first color mode represented by the first parameter.

At 203, if the second color mode represented by the value of the first parameter does not match the first color mode represented by the value of the second parameter, the display content of the first application in the running status is rendered based on the second color mode represented by the first parameter.

For example, the color mode of the first device represented by the first parameter can include the dark mode and the light mode. The second color mode represented by the value of the first parameter can be the dark mode, and the first color mode represented by the value of the second parameter can be the light mode. Then, the second color mode (the dark mode) represented by the value of the first parameter does not match the first color mode (the light mode) represented by the value of the second parameter. However, the first color mode represented by the value of the first parameter can be the light mode, which matches the first color mode represented by the value of the second parameter. Thus, the light mode can be determined based on the dark mode represented by the first parameter. Then, the display content of the first application in the running status can be rendered based on the light mode.

In some embodiments, the color mode represented by the value of the second parameter or the identifier used to indicate the color mode can be first obtained through the transmission channel and can be matched with the color mode represented by the value of the first parameter without obtaining all data of the second parameter.

In this embodiment, by obtaining the first parameter of the first device, the first color mode or the second color mode represented by the value of the first parameter can be matched with the first color mode represented by the value of the second parameter. Based on the matching result, the display content of the first application in the running status can be rendered by selecting the corresponding color mode represented by the first parameter. The identifier of the second parameter can be only obtained and can be used to be matched with the first parameter. Then, after matching, the display content of the first application in the running status can be rendered based on the first parameter without obtaining all the data of the second parameter. A low delay can be realized in the rendering process, and the response speed of the screen projection can be improved. The data amount received from the second device can be reduced. Thus, relatively few bandwidth resources can be occupied.

Embodiments of the present disclosure further provide a control method. If the second color mode represented by the value of the first parameter does not match the first color mode represented by the value of the second parameter, rendering the display content of the first application in the running status based on the second color mode represented by the first parameter can include, if the second color mode represented by the value of the first parameter does not match the first color mode represented by the value of the second parameter, configuring the first parameter representing the first color mode based on the virtual screen and rendering the display content of the first application in the running status based on the virtual screen. The virtual screen can be established based on the dimension of the screen of the second device and the target display area.

The first parameter configured for the display screen of the first device can represent the second color mode.

The first parameter configured for the virtual screen of the first device can represent the first color mode different from the second color mode.

If the second color mode represented by the value of the first parameter does not match the first color mode represented by the value of the second parameter, the first color mode represented by the value of the first parameter can be determined based on the second color mode represented by the value of the first parameter. The virtual screen can be established based on the dimension of the screen of the second device and the target display area. Then, the first parameter representing the first color mode can be configured based on the virtual screen, and the display content of the first application in the running status can be then rendered based on the virtual screen.

For example, the color mode of the first device represented by the first parameter can include a daytime mode and a nighttime mode. The second color mode represented by the value of the first parameter can be the daytime mode, and the first color mode represented by the value of the second parameter can be the nighttime mode. Then, the second color mode (the daytime mode) represented by the value of the first parameter may not match the first color mode (the nighttime mode) represented by the value of the second parameter. However, since the first color mode represented by the value of the first parameter is the nighttime mode, which matches the first color mode (the nighttime mode) represented by the value of the second parameter, the nighttime mode can be determined based on the daytime mode represented by the first parameter, and the display content of the first application in the running status can be rendered based on the nighttime mode.

Embodiments of the present disclosure further provide a control method including obtaining the second parameter periodically if the transmission channel exists.

An example of this application also provides a control method that includes:

If the transmission channel exists, the second parameter can be periodically obtained. Whether the currently obtained color mode represented by the value of the second parameter matches the color mode represented by the value of the second parameter obtained through the transmission channel last time can be determined. If not, the display content of the first application in the running status can be rendered based on the currently obtained color mode represented by the second parameter.

The color mode represented by the value of the second parameter or the identifier indicating the color mode can also be periodically obtained through the transmission channel. Whether the color mode represented by the value of the second parameter or the identifier indicating the color mode matches the color mode represented by the value of the second parameter obtained through the transmission channel last time can be determined. If not, all the data of the second parameter can be then obtained to render the display content of the first application in the running status.

In addition, the obtained second parameter can be matched with the first parameter. Based on the matching result, the corresponding color mode can be selected to render the display content of the first application in the running status.

In this embodiment, by periodically obtaining the second parameter through the transmission channel, the latest second parameter can be regularly obtained from the second device. The real-time mechanism can ensure that the first device can obtain changes in the color mode of the second device in time to provide the accurate second parameter for rendering the display content subsequently. When the change in the second parameter is discovered, the first device can render the display content of the first application based on the changed second parameter to ensure that the visual effect of the display content of the first application is consistent with the visual effect of the display content of the second application on the second device. Thus, the flexibility and real-time performance of the screen projection can be significantly improved.

Embodiments of the present disclosure further provide a control method, including, in response to the second parameter of the second device changing, receiving the changed second parameter sent by the second device through the transmission channel.

The second device can be monitored by some programs in the second device. When the changes in the second parameter is detected, the changed second parameter can be sent to the first device through the transmission channel. After receiving the changed second parameter, the first device can render the display content of the first application in the running status based on the color mode represented by the changed second parameter.

In this embodiment, the second parameter may not need to be periodically obtained. The changed second parameter sent by the monitor programs of the second device can be received only when the second parameter changes. The display content of the first application in the running status can be rendered based on the color mode represented by the changed second parameter. When the visual effect of the display content of the first application is ensured to be consistent with the visual effect of the display content of the second application, the data amount can be reduced for transmission, and the waste in the communication resources can be reduced.

As shown in FIG. 5, the control method is described based on the following scenario. The screen projection from the cell phone (the first device) to the computer (the second device) is performed.

At 301, a transmission channel is established between the cell phone and the computer via Wi-Fi Direct.

At 302, the cell device sends a screen projection request to the computer via the transmission channel. After receiving the screen projection request, the computer sends the data value (the second parameter) of the theme mode of the computer to the cell phone.

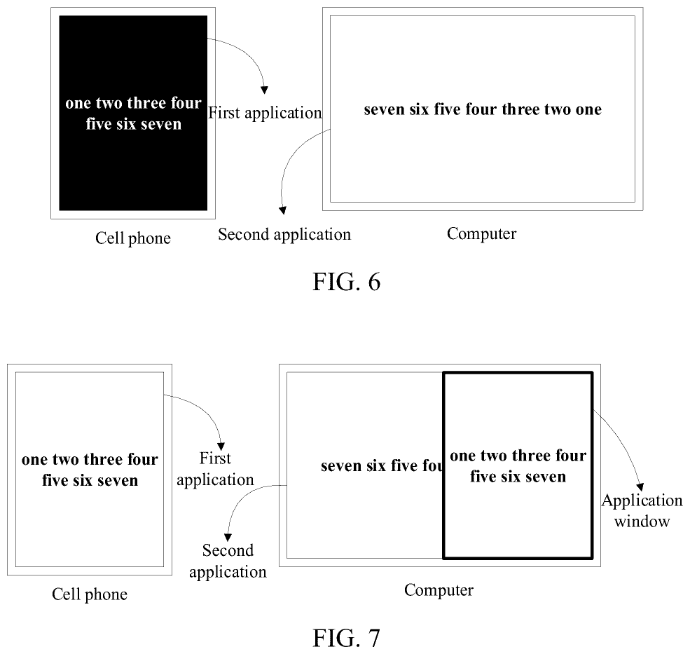

As shown in FIG. 6, before the screen projection from the cell phone to the computer, the theme mode of the first application on the cell phone is in the dark mode (foreground, e.g., fonts being white, and background being black), and the theme mode of the second application on the computer is in the light mode (foreground, e.g., fonts being black, and background being white). When the screen projection from the cell phone to the computer is performed, if the display content of the first application is not configured based on the data value of the theme mode of the computer, the theme mode of the display content of the first application displayed on the computer is also in the dark mode after the screen projection. Thus, abrupt change can occur before and after the screen projection, which causes poor user experience.

At 303, the cell phone determines that the data value of the theme mode of the computer represents the light mode. The display content of the first application is rendered based on the light mode. The display content is sent to the computer via the transmission channel. The computer establishes the application window based on the dimension of the display content and displays the display content of the text application in the application window.

When the data value of the theme mode of the computer is obtained, and the data value of the theme mode is Light (representing the theme mode as the light mode), as shown in FIG. 7, the cell phone renders the display content of the first application based on the data value of the theme mode of the computer. The theme mode of the display content of the first application on the cell phone changes to the light mode. The cell phone sends the rendered display content of the first application to the computer. The computer establishes an application window (the window with a thick outline in FIG. 7) based on the dimension of the display content of the first application sent by the cell phone and displays the display content of the first application with the theme mode as the light mode in the application window.

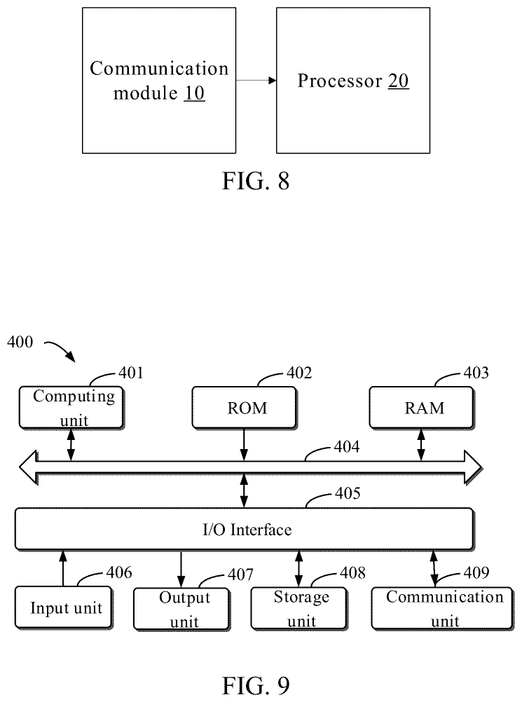

Embodiments of the present disclosure further provide a control apparatus. As shown in FIG. 8, the apparatus includes a communication module 10 and a processor 20.

The communication module 10 can be configured to establish the transmission channel with the second device.

The processor 20 can be configured to obtain the second parameter via the transmission channel. The transmission channel is a channel established with the second device. The second parameter can represent the color mode of the second device. The color mode can at least indicate the foreground color and the background color of the application. The foreground color can contrast with the background color. The processor 20 can be further configured to obtain the first application, render the display content of the first application in the running status based on the color mode represented by the second parameter, and send the display content to the second device via the transmission channel to cause the visual effect of the display content displayed by the second device to be consistent with the visual effect of the display content of the second application displayed by the second device. The first application can belong to the first device. The display content of the target application is displayed on the first device. The second application can belong to the second device.

The processor 20 can be configured to configure the second parameter based on the virtual screen. The virtual screen can be established based on the dimension of the screen of the second device and the target display area.

The processor 20 can be configured to render the display content of the first application in the running status based on the virtual screen.

The processor 20 can be configured to obtain the first parameter. The first parameter can be used to represent the color mode of the first device.

If the first color mode represented by the value of the first parameter matches the first color mode represented by the value of the second parameter, the display content of the first application in the running status can be rendered based on the first color mode represented by the first parameter.

If the second color mode represented by the value of the first parameter does not match the first color mode represented by the value of the second parameter, the display content of the first application in the running status can be rendered based on the second color mode represented by the first parameter.

The processor 20 can be configured to, if the second color mode represented by the value of the first parameter does not match the first color mode represented by the value of the second parameter, configure the first parameter representing the first color mode based on the virtual screen and render the display content of the first application in the running status based on the virtual screen. The virtual screen can be established based on the dimension of the screen of the second device and the target display area. The first parameter configured for the screen of the first device can represent the second color mode. The first parameter configured for the virtual screen of the first device can represent the first color mode different from the second color mode.

The processor 20 can be configured to periodically obtain the second parameter if the transmission mode exists.

Embodiments of the present disclosure further provide an electronic device and a computer-readable storage medium.

FIG. 9 illustrates a schematic structural diagram of an electronic device 400 according to some embodiments of the present disclosure. The electronic device can include various types of digital computer, such as laptop computers, desktop computers, workstations, personal digital assistants, servers, blade servers, mainframes, and other suitable computers. The electronic device can also include various forms of mobile apparatuses, such as personal digital processors, cell phones, smartphones, wearable devices, and other similar computing apparatuses. The components, the connections and relationships of the components, and the functions of the components are merely illustrated as examples and are not intended to limit embodiments of the present disclosure.

As shown in FIG. 9, the device 400 includes a computing unit 401, which can perform various appropriate operations and processing according to the computer programs stored in the read-only memory (ROM) 402 or loaded into the random-access memory (RAM) 403 from the storage unit 408. The RAM 403 can also store various programs and data required for the operation of the device 400. The computing unit 401, the ROM 402, and the RAM 403 are interconnected via a bus 404. An input/output (I/O) interface 405 is also connected to the bus 404.

A plurality of members connected to the I/O interface 405 in the device 400 includes an input unit 406, such as a keyboard, mouse, etc., an output unit 407, such as various types of displays, speakers, etc., a storage unit 408, such as magnetic disks, optical disks, etc., a communication unit 409, such as network cards, modems, wireless communication transceivers, etc. The communication unit 409 can allow the device 400 to exchange information/data with other devices via computer networks such as Internet and/or various communication networks.

The computing unit 401 can be various general-purpose and/or special-purpose processing assemblies. The computing unit 401 can include but is not limited to central processing units (CPU), graphics processing units (GPU), various dedicated artificial intelligence (AI) computing chips, computing units running machine learning model algorithms, digital signal processors (DSP), and any suitable processors, controllers, microcontrollers, etc. The computing unit 401 can execute various methods and processes above, such as the control methods. For example, in some embodiments, the control methods can be implemented as a computer software program, which can be tangibly stored in a machine-readable medium, such as the storage unit 408. In some embodiments, a part or all of the computer program can be loaded and/or installed onto device 400 via ROM 402 and/or communication unit 409. When the computer program is loaded into RAM 403 and executed by the computing unit 401, one or more steps of the control method described above can be performed. In some other embodiments, the computing unit 401 can be configured to perform the control method in any other suitable manners (e.g., firmware).

System and technology embodiments of the present disclosure can be implemented in digital electronic circuit systems, integrated circuit systems, field-programmable gate arrays (FPGA), application-specific integrated circuits (ASIC), application-specific standard products (ASSP), system-on-chip (SOC) devices, complex programmable logic devices (CPLD), computer hardware, firmware, software, or a combination thereof. The system and technology embodiments can be implemented in one or more computer programs. The one or more computer programs can be executed and/or explained in a programmable system including at least one programmable processor. The programmable processor can be a special-purpose or a general-purpose programmable processor, which can receive data and instructions from the storage system, the at least one input apparatus, and the at least one output apparatus and transmit the data and instructions to the storage system, the at least one input apparatus, and the at least one output apparatus.

The program codes used to implement the methods of the present disclosure can be written in any combination of one or more programming languages. The program codes can be provided to a general-purpose computer, a special-purpose computer, or processors or controllers of other programmable data processing apparatuses. Thus, when the program codes are executed by the processors or controllers, the functions/operations defined in the flowchart and/or block diagrams can be implemented. The program codes can be fully executed on a machine, partially executed on the machine, partially executed on the machine as an individual software packet and partially executed on a remote machine, or fully executed on the remote machine or server.

In the context of the present disclosure, a machine-readable medium can be a tangible medium, which can include or store a program for use by or in conjunction with an instruction execution system, apparatus, or device. A machine-readable medium can be a machine-readable signal medium or a machine-readable storage medium. The machine-readable medium can include, but is not limited to, electronic, magnetic, optical, electromagnetic, infrared, or semiconductor systems, devices, or apparatuses, or any suitable combination thereof. The machine-readable storage medium can include electrical connections based on one or more wires, portable computer disks, hard drives, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination thereof.

To provide interaction with the user, the systems and technologies described here can be implemented on the computer. The computer can include a display apparatus configured to display information to the user (such as a CRT (cathode ray tube) or LCD (liquid crystal display) monitor); and a keyboard and a pointing apparatus (e.g., a mouse or trackball). The user can provide the input to the computer through the keyboard and the pointing apparatus. Other types of apparatuses can be configured to provide the interaction with the user. For example, the feedback provided to the user can be any type of sensor feedback (e.g., visual feedback, auditory feedback, or tactile feedback). The input from the user can be received in any form (e.g., voice input, audio input, or tactile input).

The systems and technologies described here can be implemented in a computing system including back-end members (e.g., as a data server), or a computing system including middleware members (e.g., an application server), or a computing system including front-end members (e.g., a user computer with a graphical user interface or web browser, through which the user interacting with the systems and technology embodiments), or a computing system including any combination of the back-end members, middleware members, or front-end members. The members of the system can be interconnected by any form or medium of digital data communication (e.g., a communication network). Examples of communication networks can include local area networks (LAN), wide area networks (WAN), and the Internet.

A computer system can include a client end and a server end. The client end and the server end are generally away from each other and typically interact through a communication network. The client-server relationship can be generated by running computer programs running on the corresponding computers having the client-server relationship. The server can be a cloud server, a server of a distributed system, or a server integrated with blockchain.

The various forms of processes described above can be reordered, and steps can be added or deleted. For example, the steps of the present disclosure can be executed in parallel, sequentially, or in different orders, as long as the desired result of the technical solution can be achieved, which is not limited here.

Furthermore, the terms “first” and “second” are used solely for descriptive purposes and should not be understood as indicating or implying relative importance or suggesting the number of the technical features. Therefore, features described by “first” or “second” can implicitly or explicitly include at least one of such features. In the present disclosure, “a plurality of” means two or more unless explicitly specified otherwise.

The above description is merely some embodiments of the present disclosure, and the scope of the present disclosure is not limited to them. Those skilled in the art can easily think of modifications or replacements without departing from the spirit or essence of the present disclosure, which are within the scope of the present disclosure. Therefore, the scope of the present disclosure should be subject to the scope of the claims.

What is claimed is:

1. A control method comprising:
obtaining a second parameter through a transmission channel, the transmission channel being a channel established with a second device, the second parameter representing a color mode of the second device, the color mode at least indicating a foreground color and a background color of an application, the foreground color contrasting the background color;
obtaining a first application, the first application belonging to a first device;
rendering a display content of the first application in a running status, based on the color mode represented by the second parameter, the rendered display content of the first application being used to be displayed on the second device;
sending the display content through the transmission channel to the second device, so that a visual effect of the display content on the second device is consistent with a visual effect of a display content of a second application displayed on the second device, the second application belonging to the second device.

2. The method according to claim 1, further comprising:
configuring the second parameter based on a virtual screen, the virtual screen being established based on a dimension of a screen of the second device and a target display area.

3. The method according to claim 2, wherein rendering the display content of the first application in the running status based on the second parameter includes:
rendering the display content of the first application in the running status based on the virtual screen.

4. The method according to claim 1, wherein rendering the display content of the first application in the running status based on the color mode represented by the second parameter includes:
obtaining a first parameter, the first parameter used to represent the color mode of the first device;
in response to the color mode represented by a value of the first parameter matching the color mode represented by a value of the second parameter, rendering the display content of the first application in the running status based on the first color mode represented by the first parameter; and
in response to the color mode represented by the value of the first parameter not matching the color mode represented by the value of the second parameter, rendering the display content of the first application in the running status based on the second color mode represented by the first parameter.

5. The method according to claim 4, wherein in response to the color mode represented by the value of the first parameter not matching the color mode represented by the value of the second parameter, rendering the display content of the first application in the running status based on the second color mode represented by the first parameter includes:
in response to the color mode represented by the value of the first parameter not matching the color mode represented by the value of the second parameter, configuring the first parameter representing the first color mode based on a virtual screen and rendering the display content of the first application in the running status based on the virtual screen, the virtual screen being established based on a dimension of the screen of the second device and the target display area;
wherein:
the first parameter configured for a display screen of the first device represents the second color mode; and
the first parameter configured for the virtual screen of the first device represents the first color mode different from the second color mode.

6. The method according to claim 1, further comprising:
periodically obtaining the second parameter if the transmission channel exists.

7. An electronic device comprising:
a communication assembly configured to establish a transmission channel with a second device;
one or more processors configured to:
obtain a second parameter through the transmission channel, the transmission channel being a channel established with the second device through the communication module, the second parameter representing a color mode of the second device, the color mode at least indicating a foreground color and a background color of an application, the foreground color contrasting the background color;
obtain a first application, the first application belonging to a first device;
render a display content of the first application in a running status, based on the color mode represented by the second parameter, the display content of the first application being used to be displayed on the second device;
send the display content through the transmission channel to the second device, so that a visual effect of the display content on the second device is consistent with a visual effect of a display content of a second application displayed on the second device, the second application belonging to the second device.

8. The electronic device according to claim 7, wherein the one or more processors are further configured to:
configure the second parameter based on a virtual screen, the virtual screen being established based on a dimension of a screen of the second device and a target display area.

9. The electronic device according to claim 8, wherein the one or more processors are further configured to:
render the display content of the first application in the running status based on the virtual screen.

10. The electronic device according to claim 7, wherein the one or more processors are further configured to:
obtain a first parameter, the first parameter used to represent the color mode of the first device;
in response to the color mode represented by a value of the first parameter matching the color mode represented by a value of the second parameter, render the display content of the first application in the running status based on the first color mode represented by the first parameter; and
in response to the color mode represented by the value of the first parameter not matching the color mode represented by the value of the second parameter, render the display content of the first application in the running status based on the second color mode represented by the first parameter.

11. The electronic device according to claim 10, wherein the one or more processors are further configured to:
in response to the color mode represented by the value of the first parameter not matching the color mode represented by the value of the second parameter, configure the first parameter representing the first color mode based on a virtual screen and render the display content of the first application in the running status based on the virtual screen, the virtual screen being established based on a dimension of the screen of the second device and the target display area;
wherein:
the first parameter configured for a display screen of the first device represents the second color mode; and
the first parameter configured for the virtual screen of the first device represents the first color mode different from the second color mode.

12. The electronic device according to claim 7, wherein the one or more processors are further configured to:
periodically obtain the second parameter if the transmission channel exists.

13. A control apparatus comprising:
a communication module configured to establish a transmission channel with a second device;
one or more processors configured to:
obtain a second parameter through the transmission channel, the transmission channel being a channel established with the second device through the communication module, the second parameter representing a color mode of the second device, the color mode at least indicating a foreground color and a background color of an application, the foreground color contrasting the background color;
obtain a first application, the first application belonging to a first device;
render a display content of the first application in a running status, based on the color mode represented by the second parameter, the display content of the first application being used to be displayed on the second device;
send the display content through the transmission channel to the second device, so that a visual effect of the display content on the second device is consistent with a visual effect of a display content of a second application displayed on the second device, the second application belonging to the second device.

14. The apparatus according to claim 13, wherein the one or more processors are further configured to:
configure the second parameter based on a virtual screen, the virtual screen being established based on a dimension of a screen of the second device and a target display area.

15. The apparatus according to claim 14, wherein the one or more processors are further configured to:
render the display content of the first application in the running status based on the virtual screen.

16. The apparatus according to claim 13, wherein the one or more processors are further configured to:
obtain a first parameter, the first parameter used to represent the color mode of the first device;
in response to the color mode represented by a value of the first parameter matching the color mode represented by a value of the second parameter, render the display content of the first application in the running status based on the first color mode represented by the first parameter; and
in response to the color mode represented by the value of the first parameter not matching the color mode represented by the value of the second parameter, render the display content of the first application in the running status based on the second color mode represented by the first parameter.

17. The apparatus according to claim 16, wherein the one or more processors are further configured to:
in response to the color mode represented by the value of the first parameter not matching the color mode represented by the value of the second parameter, configure the first parameter representing the first color mode based on a virtual screen and render the display content of the first application in the running status based on the virtual screen, the virtual screen being established based on a dimension of the screen of the second device and the target display area;
wherein:
the first parameter configured for a display screen of the first device represents the second color mode; and
the first parameter configured for the virtual screen of the first device represents the first color mode different from the second color mode.

18. The apparatus according to claim 13, wherein the one or more processors are further configured to:
periodically obtain the second parameter if the transmission channel exists.
